(19) United States
(12) Patent Application Publication
(10) Pub. No.: US 2002/0106525 A1
(43) Pub. Date: Aug. 8, 2002

(54) High barrier and chemical resistant multi-layer laminates

(76) Inventors: Judith N. Nartey, Raleigh, NC (US); Jochen Standfuss, Weinheim (DE)

Correspondence Address: c/o RICHMOND, HITCHCOCK, FISH & DOLLAR, P.O. Box 2443, Bartlesville, OK, 74005, US

(21) Appl. No.: 09/736,533

(22) Filed: Dec. 13, 2000

Related U.S. Application Data
(60) Provisional application No. 60/173,332, filed on Dec. 28, 1999.

(51) Int. Cl. B32B 27/08

(52) U.S. Cl. 428/517; 428/518; 428/520; 156/244.11

(57) ABSTRACT

This invention provides high barrier and chemical resistant multi-layer laminates. More specifically, this invention provides multi-layer laminates comprising at least one A-B double layer structure, characterized in that film layer A comprises at least one monovinylarene/conjugated diene block copolymer and film layer B comprises at least one polyvinylidene chloride.

This application claims priority to provisional application 60/173,332 filed Dec. 28, 1999.

### FIELD OF THE INVENTION

This invention is related to the field of high barrier and chemical resistant multi-layer laminates. More specifically, this invention is related to the field of multi-layer laminates comprising at least one A-B double layer structure, characterized in that film layer A comprises at least one monovinylarene/conjugated diene block copolymer and film layer B comprises at least one polyvinylidene chloride.

### BACKGROUND OF THE INVENTION

Monovinylarene/conjugated diene block copolymers are known in the art and are useful for a variety of purposes. These copolymers can be formed into colorless, transparent articles. Such articles are useful for example in packaging, such as beverage containers, formed web, and blister packaging, and in the manufacture of toys, medical devices, display parts, thermoformed single service items, and food containers and beverage containers.

For many food packaging applications, such as, for example, candy, meat, and cheese, high barrier chemical resistant packaging is a necessity. The packaging must be chemical resistant to prevent breakage. Furthermore, the packaging must provide a good barrier in order to retain fats and oils contained in the food. Additional requirements include clarity and formability.

Monovinylarene/conjugated diene block copolymers, such as styrene-butadiene copolymers, offer excellent clarity and formability, but provide insufficient barrier and chemical resistant properties. There is a need in the industry for monovinylarene/conjugate diene block copolymer laminate that provides good barrier and chemical resistant properties.

### SUMMARY OF THE INVENTION

It is an object of this invention to provide a process for making a multi-layer laminate comprising at least one A-B double layer structure, characterized in that film layer A comprises at least one monovinylarene/conjugated diene block copolymer and film layer B comprises at least one polyvinylidene chloride.

It is another object of this invention to provide a multi-layer laminate comprising at least one A-B double layer structure, characterized in that film layer A comprises at least one monovinylarene/conjugated diene block copolymer and film layer B comprises at least one polyvinylidene chloride

### DETAILED DESCRIPTION OF THE INVENTION

In a first embodiment of this invention, a process for producing a multi-layer laminate comprising at least one A-B double layer structure is provided. The process comprises laminating film layer A and film layer B. Film layer A comprises at least one monovinylarene/conjugated diene block copolymer, and film layer B comprises at least one polyvinylidene chloride. The terms “laminate”, “laminating”, or “laminated” mean to firmly unite at least two film layers. Film layer A can comprise the outer or the inner film layer of the multi-layer laminate. Additional film layers can be added to the A-B double layer structure to produce multi-layer laminates for various functions.

Any monovinylarene/conjugated diene block copolymers, hereinafter referred to as “block copolymers”, known in the art can be utilized in this invention. Generally, the block copolymers useful in this invention have a melt flow index greater than about 0.1 g/10 minutes, preferably in the range of 0.1 g/10 minutes to 100 g/10 minutes (measured according to ASTM D-1238, condition G). A melt flow lower than 0.1 g/10 minutes significantly inhibits flow while a melt flow greater than 100 g/10 minutes indicates a block copolymer with a molecular weight which is too low to obtain desirable mechanical properties.

Block copolymers generally can be prepared by a solution process involving sequential polymerization of a monovinylarene monomer and a conjugated diene monomer. Optionally, a monovinylarene monomer/conjugated diene monomer mixture can be polymerized to form a block copolymer. In some circumstances, if desired, the polymer chains can be coupled to form multimodal block copolymers having a broad molecular weight distribution.

The basic starting materials and polymerization conditions for preparing block copolymers are disclosed in U.S. Pat. Nos. 4,091,053; 4,584,346; 4,704,435; and 5,227,419; the entire disclosures of which are herein incorporated by reference.

In a typical preparation method, a conjugated diene monomer and a monovinylarene monomer are copolymerized sequentially in the presence of an initiator. The initiators can be any organomonoalkali metal compound known for such purposes. Preferably, the initiator is provided in at least two charges. Small amounts of polar organic compounds, such as ethers, thioethers, and tertiary amines can be employed in the hydrocarbon diluent to improve the effectiveness of the initiator and to randomize at least part of the monovinylarene monomer in a mixed monomer charge. The polymerization process is carried out in a hydrocarbon diluent at any suitable temperature, preferably in the range of −100 to 150° C., and at a pressure sufficient to maintain the reaction mixture in a substantially liquid phase. Each monomer charge or monomer mixture charge is polymerized under solution polymerization conditions such that the polymerization of each monomer charge or monomer mixture is substantially complete before charging a subsequent charge. If desired, a coupling agent can be added after polymerization is complete.

Conjugated dienes having about 4 to about 12 carbon atoms per molecule are suitable and can be used in the copolymers of the present invention. Conjugated dienes having 4 to 8 carbons atoms are preferred to optimize the physical properties of the block copolymer, such as, for example, impact strength. Conjugated dienes can be selected from the group consisting of 1,3-butadiene; 2-methyl-1,3-butadiene; 2-ethyl-1,3-butadiene; 2,3-dimethyl-1,3-butadiene; 1,3-pentadiene; 3-butyl-1,3-octadiene; and mixtures thereof. 1,3-butadiene and isoprene are preferred, and 1,3-butadiene is most preferred.

Suitable monovinylarene compounds, which can be used to produce the block copolymers, include those having about 8 to about 18 carbon atoms per molecule, preferably 8 to 12 carbon atoms so as to enhance the ease of polymerizing. Examples of such suitable monovinylarene compounds include styrene; alpha-methylstyrene; 2-methylstyrene; 3 methylstyrene; 4-methylstyrene; 2-ethylstyrene; 3-ethylstyrene; 4-ethylstyrene; 4-n-propylstyrene; 4-t-butylstyrene, 2,4-dimethylstyrene; 4-cyclohexylstyrene; 4-decylstyrene; 2-ethyl-4-benzylstyrene; 4-(4-phenyl-n-buyl)styrene; 1-vinylnaphthalene; 2-vinylnaphthalene; and mixtures thereof. Styrene is the preferred monovinylarene compound due to its reactivity as well as its cost efficiency.

Generally, the block copolymer will contain monovinylarene monomer in an amount in a range of from about 55 weight percent to about 95 weight percent based on the total weight of the final block copolymer, preferably in a range of from about 60 weight percent to about 95 weight percent, and more preferably in a range of about 70 weight percent to about 90 weight percent so as to maximize clarity, stiffness, and processability in the final block copolymer.

Generally, the conjugated diene monomer will be present in the final block copolymer in an amount in a range of from about 45 weight percent to about 5 weight percent based on the total weight of the final block copolymer, preferably in a range of from about 40 weight percent to about 5 weight percent, and more preferably, in a range of from 30 weight percent to 10 weight percent so as to maximize clarity, stiffness, and processability in the final block copolymer.

The polyvinylidene chloride, hereinafter referred to as “PVDC”, used in this invention can be a homopolymer or copolymer. The homopolymer comprises polymerized vinylidene chloride. The copolymer comprises polymerized vinylidene chloride and at least one polymerized monoethylenically unsaturated monomer. Preferably, the copolymer has polymerized therein vinylidene chloride in an amount in a range from about 40 to 98% by weight based on the weight of the polyvinylidene chloride copolymer and at least one monoethylenically unsaturated monomer in an amount in a range of from about 60 to about 2% by weight based on the weight of the polyvinylidene chloride copolymer. The monoethylenically unsaturated monomer can be selected from the group consisting of vinyl chloride; alkyl esters of acrylic and methacrylic acids, such as alkyl acrylates and alkyl methacrylates; ethylenically unsaturated mono- and dicarboxylic acids, such as acrylic acid, methacrylic acid, and itaconic acid; and cyano-functional monomers, such as acrylonitrile and methacrylonitrile.

Multi-layer laminates can be produced by any means known in the art. Generally, a film layer can be produced by blown or cast film techniques. To produce a multi-layer laminate more than one layer of film must be laminated together. For example, the multi-layer laminate can be produced using conventional extrusion techniques such as feedblock coextrusion, multi-manifold die coextrusion, or combinations of the two. In coextrusion, two or more polymers are simultaneously extruded through one die. Two or more extruders are used simultaneously to feed the die. Typically, there is an adapter and feedblock between the die and the extruder. In this process, various polymer melts are introduced into the die lips under conditions of laminar flow such that there is no intermixing, but bonding occurs at the interface between the film layers. For example, in this invention, to produce an A-B double layer structure, the block copolymer is extruded through one extruder and the PVDC is extruded through another. To produce the multi-layer laminates in this invention, the coextrusion process is preferred.

Multi-layer laminates also can be produced by extrusion coating. Typically, in an extrusion coating process, a pre-extruded film layer is heated, and an extruder is utilized to melt a second material to produce a second film layer onto the pre-extruded film layer. The pre-extruded film layer and the second film layer are forced together under pressure usually using a rubber roll. A number of methods are utilized to increase adhesion between the pre-extruded film layer and the second film layer. For example, a primer can be placed on the pre-extruded film layer. Primers are selected based on the particular polymers utilized, the processing conditions, and the final usage of the multi-layer laminate. Examples of primers include, but are not limited to, polyalkylenamine, organic titanates, polyurethanes, polyesters, and colloidal silica. Typically, primers are applied as lacquers, solvent dispersions, or aqueous dispersions in a thin layer of less than about 0.001 inches. Primers can be applied to one or both sides of the pre-extruded film layer depending on the application. In this invention, film layer A or film layer B can serve as the pre-extruded layer.

Multi-layer laminates also can be produced by a coating method. In this process, a pre-extruded film layer is coated with a second material. The second material can be placed on the pre-extruded film as lacquers, solvent dispersions, or aqueous dispersions. For example, in this invention, a pre-extruded film layer A comprising at least one block copolymer can be coated with PVDC that has been mixed with other compounds to produce a lacquer.

The volume or thickness of each individual film layer in the multi-layer laminate can be controlled as it is extruded or coated on a pre-extruded film layer. Thus, the overall thickness of the multi-layer laminate can be controlled to produce a multi-layer film or sheet of desired thickness. In this disclosure, film is defined as material less than 0.01 inch thick. Material over 0.01 inch in thickness is called a sheet.

An adhesion or tie layer is not required between film layer A and film layer B. It can be appreciated that production of the multi-layer laminate is greatly simplified by the elimination of a tie layer. For example, coextrusion is immediately simplified because intermediate tie layers need not be coextruded. Hence, the coextrusion die employed, for example, to produce a double layer structure only requires two separate passageways, rather than three. Of course, if an optional tie layer is to be employed, as described subsequently, then a conventional coextrusion die can be utilized.

Other optional layers can be included in the A-B double layer structure to provide additional features such as rigidity and toughness to produce multi-layer laminates for various purposes. In addition, while a tie layer is not required between film layer A and film layer B, it should be noted that a separate tie layer can optionally be employed. Such a use may be desired where the adhesion between the film layers are not adequate for the intended use. Suitable tie layer polymers include, but are not limited to, chlorinated polyolefins, such as chlorinated polyethylene having from about 25 to about 45% by weight chlorine and chlorinated polypropylenes having up to about 65% by weight chlorine; ethylene vinyl acetate copolymer; ethylene vinyl alcohol copolymer; and thermoplastic elastomers containing anhydrides. Commercially available products include ethylene vinyl acetate copolymer available under the tradename Bynel CXA 1025 from Shell Chemical Company, ethylene vinyl alcohol copolymer available under the tradename EVA 3125 obtained from DuPont and thermoplastic elastomers such as Kraton® FG 1901X Rubber.

The amount of film layer A and film layer B in the multi-layer laminate varies depending on its use. When an A-B double layer structure is produced, the amount of layer A in the multi-layer laminate ranges from about 75% to 95% by weight and preferably, from 80 to 95% by weight based on the weight of the A-B double layer structure with the remaining amount being film layer B.

It should be noted that any or all film layers of the multi-layer laminate can be colored, if desired. Likewise, fillers, pigments, dyes, antistatic compounds, bacteriosides, and other common additives can be included in one or more film layers of the multi-layer laminate.

In a second embodiment of this invention, a process is provided to produce an A-B-C triple layer structure. The process comprising laminating film layer A, film layer B, and film layer C to produce the A-B-C triple layer structure. Film layers A and B were previously discussed in the first embodiment. Film layer C functions as a sealing layer capable of adhering to various materials by the use of heat or pressure according to the usage of the A-B-C triple layer structure. Examples of materials utilized in the sealing layer include, but are not limited to, linear low density polyethylene and ethylene vinyl alcohol. Preferably, film layer A is the outside layer of the A-B-C triple layer structure; film layer B is a layer sandwiched between film layers A and C; and film layer C is the inner layer of the A-B-C triple layer structure.

Coextrusion, extrusion coating, and coating methods, as discussed previously, can be utilized to produce the A-B-C triple layer structure. When an A-B-C triple layer structure is produced, the amount of layer A in the multi-layer laminate ranges from about 55% to about 90% by weight, preferably from about 65 to about 90%, and most preferably from 65 to 80% by weight based on the weight of the A-B-C triple layer structure. The amount of film layer B in the A-B-C triple layer structure ranges from about 5% to about 25% by weight, preferably from about 5 to about 20%, and most preferably from 10 to 15% by weight based on the weight of the A-B-C triple layer structure. The amount of film layer C in the A-B-C triple layer structure ranges from about 5% to about 20% by weight, preferably from about 5 to about 15%, and most preferably from 10 to 15% by weight based on the weight of the A-B-C triple layer structure.

In a third embodiment, a process is provided to produce an A-B-C-D layered structure. The process comprises laminating film layer A, film layer B, tie layer D and film layer C. Film layers A, B, and C were previously discussed in this disclosure. Tie layer D is interposed between film layer B and film layer C to increase adhesion therebetween, typically during a multilayer coextrusion process. The type of tie layer depends on the sealing layer selected for film layer C. Preferably, film layer A is the outside layer of the A-B-C-D layered structure; film layer B is a layer interposed between film layer A and tie layer D; tie layer D is interposed between film layers B and C; and film layer C is the inner layer of the A-B-C-D layered structure.

Coextrusion, extrusion coating, and coating methods, as discussed previously, can be utilized to produce the A-B-C-D layered structure. When an A-B-C-D layered structure is produced, the amount of film layer A in the A-B-C-D layered structure ranges from about 40% to about 85% by weight and preferably from 55 to 85% by weight based on the weight of the A-B-C-D layered structure. The amount of film layer B in the A-B-C-D layered structure ranges from about 5% to about 25% by weight, preferably from about 5 to about 20%, and most preferably from 10 to 20% by weight based on the weight of the A-B-C-D layered structure. The amount of film layer C in the A-B-C-D layered structure ranges from about 5% to about 20% by weight, preferably from about 5 to about 15%, and most preferably from 10 to 15% by weight based on the weight of the A-B-C-D layered structure. The amount of tie layer D in the A-B-C-D layered structure ranges from about 5% to about 15% by weight and preferably from 5 to 10% by weight based on the weight of the A-B-C-D layered structure.

Articles can be produced from the multi-layer laminates of this invention. For example, these multi-layer laminates can be used in food packaging, balloons, and other articles.

### EXAMPLES

Test Methods Utilized

Test methods are shown in Table I except for shrinkage.

Shrinkage—ASTM-D2732 was utilized.

Materials Used to Produce Laminates

K-Resin® & Styrene-Butadiene Copolymer, Grade DK12 produced by Phillips Petroleum Company;

Polyvinylidene chloride obtained as Saran ®XPR102 from Dow Chemical Company;

Ethylene vinyl alcohol obtained as EVA® 3125 from DuPont;

Linear Low Density Polyethylene obtained as Dowlex ®3010 from Dow Chemical Company

Production of Multi-Layer Laminates

Multi-layer laminates, laminate I and laminate II, were fabricated by coextrusion to a 4 mil thickness. Tests were conducted per ASTM procedures shown in Table 1. The data are also shown in Table 1.

Laminate I had three film layers, A, B, and C, with a tie layer between A and B, and a tie layer between B and C. Film layer A comprising DK12 was the outer layer. Film layer B comprising Saran XPR102 was the second film layer. Film layer C comprising Dowlex 3010 was the inner film layer.

Laminate II also had three film layers, A, B, and C, with one tie layer between film layers B and C. Film layer A comprising DK12 was the outer layer. Film layer B comprising Saran XPR102 was the second film layer. Film layer C comprising Dowlex 3010 was the inner film layer.

Laminates I and II were produced by adding DK12, Saran XPR102, EVA 3125 and Dowlex 3010 pellets to separate extruders connected to a film die for coextrusion.

Analysis of Results

Comparison of laminates I and II shows that they have similar properties even though laminate II does not have a tie layer between film layers A and B. Elimination of this tie layer will greatly simplify and reduce the cost of producing multi-layer laminates.

TABLE 1

| | ASTM | | Laminate | Laminate |
|---|---|---|---|---|
| Test | Method | Units | A (4 mil) | B (4 mil) |
| OTR | D3985 | cc*mil/ | 0.87 | 1.8 |
| | | 100 in²*24 h | | |
| MVTR | E96@ | g*mil/ | 0.081 | 0.073 |
| | 23° C. | 100 in²*24 h | | |
| Tensile Yield Strength | | | | |
| Machine Direction | D882 | psi | 2,500 | 3,000 |
| Transverse Direction | D882 | psi | 2,050 | 2,450 |
| Secant Modulus 1% | | | | |
| Machine Direction | D882 | psi | 75,000 | 91,500 |
| Transverse Direction | D882 | psi | 42,500 | 52,850 |
| Dart Drop, 26 inches | D1709 | g | 176 | 240 |
| Puncture | D3763 | in-lbs | 41.8 | 61.5 |
| Shrinkage | | | | |
| Machine Direction | | % | 41 | 60 |
| Transverse Direction | | % | 1 | 0 |
| Peel/Layer Adhesion | | | | no peel |

While this invention has been described in detail for the purpose of illustration, it is not intended to be limited thereby but is intended to cover all changes and modification within the spirit and scope thereof.

That which is claimed is:

1. A process of making a multi-layer laminate comprising at least one A-B double layer structure said process comprising laminating film layer A and film layer B;
wherein said film layer A comprises at least one monovinylarene/conjugated diene block copolymer; and
wherein said film layer B comprises at least one polyvinylidene chloride.

2. A process according to claim 1 further comprising laminating film layer C;
wherein film layer C functions as a sealing layer capable of adhering to various materials by heat or pressure according to the usage of said multi-layer laminate;
wherein said film layer A is the outside layer of said multi-layer laminate;
wherein said film layer B is the layer sandwiched between film layers A and C; and
wherein said film layer C is the inner layer of said multi-layer laminate.

3. A process according to claim 2 further comprising interposing a tie layer between film layers B and C to increase adhesion therebetween.

4. A process according to claim 3 further comprising interposing a tie layer between film layers A and B to increase adhesion therebetween.

5. A process according to claim 1 wherein said laminating is conducted by coextrusion.

6. A multi-layer laminate produced by claim 1.

7. A multi-layer laminate produced by claim 2.

8. A multi-layer laminate produced by claim 3.

9. A multi-layer laminate produced by claim 4.

10. A multi-layer laminate comprising at least one A-B double layer structure, characterized in that film layer A comprises at least one monovinylarene/conjugated diene block copolymer and film layer B comprises at least one polyvinylidene chloride.

11. A multi-layer laminate according to claim 10 further comprising film layer C;
wherein film layer C functions as a sealing layer capable of adhering to various materials by heat or pressure according to the usage of said multi-layer laminate;
wherein said film layer A is an outside layer of said multi-layer laminate;
wherein said film layer B is a layer sandwiched between film layers A and C; and
wherein said film layer C is an inner layer of said multi-layer laminate.

12. A multi-layer laminate according to claim 11 further comprising a tie layer interposed between film layer B and film layer C to increase adhesion therebetween.

13. A multi-layer laminate according to claim 12 further comprising a tie layer interposed between film layer A and film layer B to increase adhesion therebetween.

14. A multi-layer laminate according to claim 13 wherein said tie layer is selected from the group consisting of chlorinated polyolefins, ethylene vinyl acetate copolymer, ethylene vinyl alcohol copolymer, and thermoplastic elastomers containing anhydrides.

15. A multi-layer laminate consisting essentially of a A-B double layer structure, characterized in that film layer A consists essentially of monovinylarene/conjugated diene block copolymer and film layer B consists essentially of polyvinylidene chloride.

16. A multi-layer laminate consisting essentially of an A-B-C-triple layer structure, characterized in that film layer A consists essentially of monovinylarene/conjugated diene block copolymer, film layer B consists essentially of polyvinylidene chloride, and film layer C consists essentially of a sealing layer capable of adhering to various materials according to the usage of said multi-layer laminate.

17. A multi-layer laminate according to claim 16 wherein film layer A is the outside film layer, film layer B is sandwiched between film layer A and C, and film layer C is the inside layer.

18. A multi-layer laminate according to claim 17 further comprising a tie layer interposed between film layer B and film layer C to increase adhesion therebetween.

19. A multi-layer laminate according to claim 18 further comprising a tie layer interposed between film layer A and film layer B to increase adhesion therebetween.

20. An article produced from said multi-layer laminate of claim 10.

21. An article produced from said multi-layer laminate of claim 11

22. An article produced from said multi-layer laminate of claim 12.

23. An article produced from said multi-layer laminate of claim 13.

24. An article produced from said multi-layer laminate of claim 14.
